(19) United States
(12) Patent Application Publication
(10) Pub. No.: US 2016/0125439 A1
(43) Pub. Date: May 5, 2016

(54) METHODS AND APPARATUS TO CORRECT SEGMENTATION ERRORS

(71) Applicant: The Nielsen Company (US), LLC, Schaumburg, IL (US)

(72) Inventors: Michael Sheppard, Brooklyn, NY (US); Peter Lipa, Tucson, AZ (US); Alejandro Terrazas, Santa Cruz, CA (US); Wei Xie, Woodridge, IL (US); Matthew Reid, Alameda, CA (US)

(21) Appl. No.: 14/529,409

(22) Filed: Oct. 31, 2014

(51) Int. Cl. G06Q 30/02

(52) U.S. Cl. CPC G06Q 30/0204

(57) ABSTRACT

Methods, apparatus, systems and articles of manufacture are disclosed to correct segmentation errors. An example disclosed method includes identifying, with a processor, a segment group comprising observation data associated with two or more segments, respective ones of the two or more segments having a similar first characteristic and a dissimilar second characteristic, identifying first portions of the observation data having errors, generating a first matrix of binary indicators associated with the observation data, the binary indicators associating the first portions of the observation data with a first correction factor, and generating a value for the first correction factor by minimizing a residual sum of squares of the segment group observation data associated with the first matrix of binary indicators.

### FIELD OF THE DISCLOSURE

This disclosure relates generally to market research, and, more particularly, to methods and apparatus to correct segmentation errors.

### BACKGROUND

Media research efforts typically include acquiring and organizing data related to one or more market behaviors. In some cases, market behaviors relate to purchasing activity, travel activity, Internet browsing activity and/or retail visiting activities. Market researchers and/or personnel chartered with a responsibility to manage acquired market behavior information may organize such information based on segments of similar types of shoppers (e.g., respondents, panelists, customers, potential customers, etc.). For example, shopping information for a particular retailer may be organized into groups that define a corresponding shopper demographic segment (e.g., males age 18-24, females age 29-33, etc.).

### BRIEF DESCRIPTION OF THE DRAWINGS

FIG. 1 is a plot of five (5) example data sets that are respectively associated with a separate segment of consumer classification, in which erroneous data resides.

FIG. 2 is a schematic illustration of an example segmentation analyzer to correct segmentation errors.

FIG. 3 is a plot of the five (5) example data sets of FIG. 1 after applying corrections with the example segmentation analyzer of FIG. 2.

FIGS. 4-6 are flowcharts representative of example machine readable instructions that may be executed to implement the example segmentation analyzer of FIG. 2.

FIG. 7 is a schematic illustration of an example processor platform structured to execute the instructions of FIGS. 4-6 to implement the example segmentation analyzer of FIG. 2.

### DETAILED DESCRIPTION

Market researchers seek to identify the demographic composition associated with market behaviors, such as persons who have engaged in, observed, and/or otherwise collected market behavior. For example, a manufacturer of bottled water may seek information related to typical purchasing behaviors to determine which particular demographic of interest is best suited for targeted advertisement (e.g., males 18-24, females 28-32, etc.). In the event a particular demographic segment of interest exhibits a particularly strong interest in the bottled water product, then the manufacturer may tailor one or more marketing efforts to better suit the target demographic segment of interest.

In other examples, an advertising campaign effect may be more pronounced with a first demographic segment when compared to a second demographic segment. Knowledge of such effects associated with particular segments may reveal an effectiveness of the advertising campaign itself, and/or may reveal trending information for particular segments.

Data associated with one or more segments may be subject to classification errors. For example, a portion of data from a first segment may be mislabeled such that it is included in a second segment. While the collected data may be accurate (e.g., four bottles of water purchased by a first consumer that is a member of the first segment, seven bottles of water purchased by a second consumer that is a member of the second segment, etc.), corresponding segment labels may be inaccurate. As used herein, “segment labels” include information associated with a collected behavior data point that identifies an associated demographic of that data point. Erroneous labeling of data may result in lost revenue if a market researcher relies upon the erroneous data associated with a particular demographic group that is not accurately represented by segment data points. For example, the market researcher may rely upon segment data that is erroneously associated with a first demographic group (e.g., males age 18-24) when, in fact, the segment data is actually associated with behavior of a second demographic group (e.g., females age 25-29). Similarly, erroneous labeling may result in lost clients and/or lost opportunities to design an effective marketing strategy using acquired consumer behavior data. Erroneous segment labels may also result in wasted processing cycles of computers when generating forecasting that must be repeated with augmented and/or otherwise corrected data after the error is discovered.

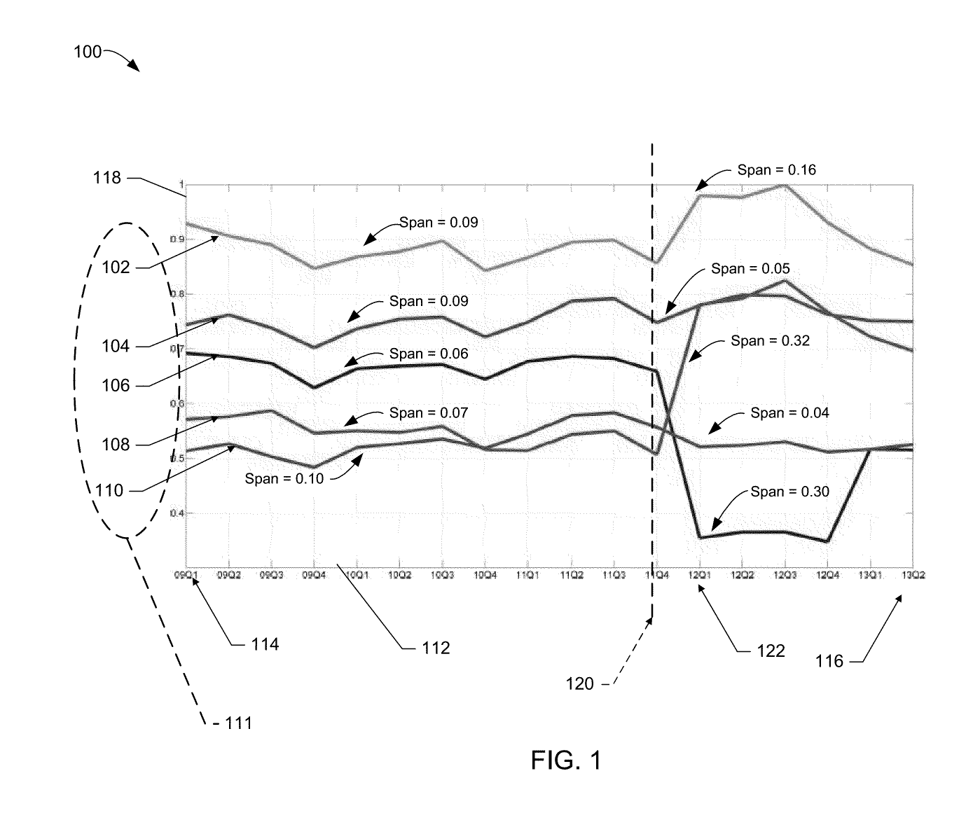

FIG. 1 is a plot 100 of five (5) example data sets that are respectively associated with different segments of demographic classification. A group of segments that share a similar characteristic are referred to herein as a “segment group.” In the illustrated example of FIG. 1, the plot 100 includes a first segment 102, a second segment 104, a third segment 106, a fourth segment 108 and a fifth segment 110, collectively referred to herein as a segment group 111. Data associated with each of the five example segments spans a horizontal axis of time 112 from a first quarter of 2009 (114) to a second quarter of 2013 (116). Additionally, the data associated with the five example segments includes corresponding magnitude values (units) 118 that have been normalized, for convenience of discussion, between zero and one. The five (5) example segments of FIG. 1 may reflect any type of data, including, but not limited to consumer purchase behaviors, consumer store visits, consumer Internet site visits, etc. For example, assume the example segment group 111 reflects a relative quantity of a particular beverage (e.g., a similar characteristic of a branded water beverage, a sports drink, etc.) purchased during the quarters identified in the horizontal axis of time 112. Each one of the five (5) example segments of the segment group 111 has a dissimilar characteristic relative to every other segment. In the illustrated example of FIG. 1, the dissimilar characteristic is a particular demographic associated with the beverage purchasing behavior (e.g., the first example segment 102 reflects beverage purchases by males age 18-24, the second example segment 104 reflects beverage purchases by females age 18-24, the third example segment 106 reflects beverage purchases by females age 25-29, the fourth example segment 108 reflects beverage purchases by males age 25-29, and the fifth example segment 110 reflects beverage purchases by females age 30-34).

In some examples, data points associated with market activity are acquired by one or more data acquisition systems, such as the Homescan® system by The Nielsen Company®. In some examples, the data points are organized and/or otherwise manipulated by one or more market researchers. This organization and/or manipulation may introduce error(s) into the data. For example, a market researcher may manipulate collected data in a spreadsheet prior to generating one or more reports and inadvertently move data from a first segment (e.g., associated with males age 18-24) to a second segment (e.g., associated with females age 18-24). While the collected data itself may be accurate regarding, for example, a quantity of beverages purchased during a period of time, the erroneous classification may cause errors in one or more conclusions derived from the collected data. In other words, while some portions of the data may be inaccurate (e.g., a label associated with some of the data indicative of an incorrect segment), other portions of the data may still be accurate (e.g., a number of units sold).

In the illustrated example of FIG. 1, all five example data sets (e.g., each associated with a different particular demographic segment) of the segment group 111 exhibit relatively consistent behavior between the first quarter of 2009 (114) and a fourth quarter of 2011 (120). A degree of consistent behavior may be identified in any number of ways. For example, data fully between one or more thresholds associated with upper and lower magnitudes of each data set may be labeled consistent. In the example of FIG. 1, respectively, data collected between the first quarter of 2009 (114) and the fourth quarter of 2011 (120), the first segment 102 spans a magnitude of 0.09 units (i.e., the difference between the highest value (0.93) and the lowest value (0.84) is 0.09), the second segment 104 spans a magnitude of 0.09 units (i.e., the difference between the highest value (0.79) and the lowest value (0.70) is 0.09), the third segment 106 spans a magnitude of 0.06 units (i.e., the difference between the highest value (0.69) and the lowest value (0.63) is 0.06), the fourth segment 108 spans a magnitude of 0.07 units (i.e., the difference between the highest value (0.59) and the lowest value (0.52) is 0.08), and the fifth segment 110 spans a magnitude of 0.10 units (i.e., the difference between the highest value (0.58) and the lowest value (0.48) is 0.10). In still other examples, consistent behavior may be defined via comparisons to prior observed trending activity. In addition to trending information, one or more deviations from prior observed seasonality components may be used to determine whether a segment exhibits consistent or inconsistent behavior. Seasonality components may include, but are not limited to one or more national and/or regional holidays (e.g., Valentine's day, Mother's day, Black Friday, etc.).

As shown above, the five example data sets of FIG. 1 exhibit values that span a magnitude of no more than 0.10 units and span a magnitude of no less than 0.06 units during the observed time period between the first quarter of 2009 (114) and the fourth quarter of 2011 (120). Such example magnitudes of span may be deemed normal behavior in some instances, while in other instances such example magnitudes of span may be deemed excessive and/or otherwise erroneous. While examples disclosed herein employ a test for consistent behavior with upper and lower thresholds related to a span of values for corresponding data sets, example methods, apparatus, systems and/or articles of manufacture disclosed herein are not limited thereto. For example, additional and/or alternate manners of identifying a degree of consistent behavior in one or more data sets and/or a degree of erratic behavior in one or more data sets may include establishing and/or otherwise identifying differences in linear models based on prior consistent behavior and known seasonal or holiday behavior. In other words, sudden or drastic changes in the span of the data may provide an indication that a trend break has occurred.

A group of segments, such as the example segment group 111 of five data sets 102-110 of FIG. 1, may be related with respect to a first characteristic. For example, all of the five example data sets 102-110 of FIG. 1 may reflect a same first characteristic related to a same consumer behavior. Example consumer behaviors include purchases of a particular product (of a quantity of sales for a branded beverage), purchases of a particular brand, exposure to particular media, and/or travel behavior. On the other hand, the example group of segments 111 may also exhibit different (e.g., heterogeneous) behaviors with respect to a second characteristic. For example, each individual segment 102, 104, 106, 108, 110 may be respectively associated with a different second characteristic (e.g., a unique demographic) Because of one or more differences and/or commonalities between the respective different segments 102, 104, 106, 108, 110 of the example segment group 111, discarding data in response to identifying an error is detrimental. For example, such discarding eliminates an opportunity to identify other interrelationships, differences, commonalities and/or the characteristics of the data that may be helpful to market analysis (e.g., trending information).

Returning to the illustrated example of FIG. 1, assume that a threshold span of a magnitude of 0.15 units is established to identify a segment (data set) that is deemed abnormal and/or otherwise indicative of erratic behavior. For purposes of this example, any segment exhibiting a span larger than the threshold span will be identified as abnormal. However, identifying erratic, abnormal or otherwise inconsistent segment data may occur in any number of ways, such as identifying trend breaks and/or deviations in trending, as described above. Because the five example segments of FIG. 1 each exhibit a magnitude span value less than the threshold span of 0.15 units between the first quarter of 2009 (114) and the fourth quarter of 2011 (120), those corresponding portions of the example five segments are deemed to be normal. However, the five (5) example segments exhibit a different behavior between the fourth quarter of 2011 (120) and the second quarter of 2013 (116). In particular, in this timeframe the first segment 102 spans a magnitude of 0.16 units (i.e., the difference between the highest value (1.00) and the lowest value (0.84) is 0.16 units), the second segment 104 spans a magnitude of 0.05 units (i.e., the difference between the highest value (0.80) and the lowest value (0.75) is 0.05 units), the third segment 106 spans a magnitude of 0.30 units (i.e., the difference between the highest value (0.65) and the lowest value (0.35) is 0.30 units), the fourth segment 108 spans a magnitude of 0.32 units (i.e., the difference between the highest value (0.83) and the lowest value (0.51) is 0.32 units), and the fifth segment 110 spans a magnitude of 0.04 units (i.e., the difference between the highest value (0.55) and the lowest value (0.51) is 0.04 units). The first example segment 102, the third example segment 106 and the fourth example segment 108, thus, exceed the magnitude threshold span value of 0.15 units. As such, the portion of first, third and fourth segments between the fourth quarter of 2011 and the second quarter of 2013 are identified as exhibiting abnormal and/or otherwise erratic behavior.

When faced with one or more data sets that fail one or more quality tests, such as exceeding one or more threshold values indicative of the possible erroneous data and/or threshold deviation(s) from prior consistent behavior (e.g., trend variation, prior seasonality observation, etc.), in the past market researchers typically delete the apparent erroneous portions of data and calculate projections and/or estimations based on one or more prior data sets that did not exhibit erroneous behavior. For example, past approaches to utilizing the example data of FIG. 1 would result in deletion of all of the segment data for the example first segment 102, the example third segment 106, and the example fourth segment 108 between the fourth quarter of 2011 (120) and the second quarter of 2013 (116). In other words, approximately 1½ years of the most recent segment data would be deleted, and replaced with projections based on old data from the previous six quarters. Proceeding with a market analysis after deleting apparently erroneous data and replacing the deleted data with the prior (older) data set(s) causes older trending information to be erroneously included in the segment models.

Furthermore, while portions of the erroneous data were incorrect, other portions of the erroneous data may have useful information therein (e.g., trending information). Nonetheless, past approaches discarded this data in favor of projections based on relatively older/stale data from one or more prior time periods. Rather than merely discarding data having one or more indications of error (e.g., one or more segments that exceed one or more span threshold values), example methods, systems, apparatus and/or articles of manufacture disclosed herein correct the erroneous data. A benefit of correcting the erroneous data rather than merely discarding the erroneous data is that available trending information in the erroneous data may be preserved to facilitate additional consumer trending insight to the market researcher.

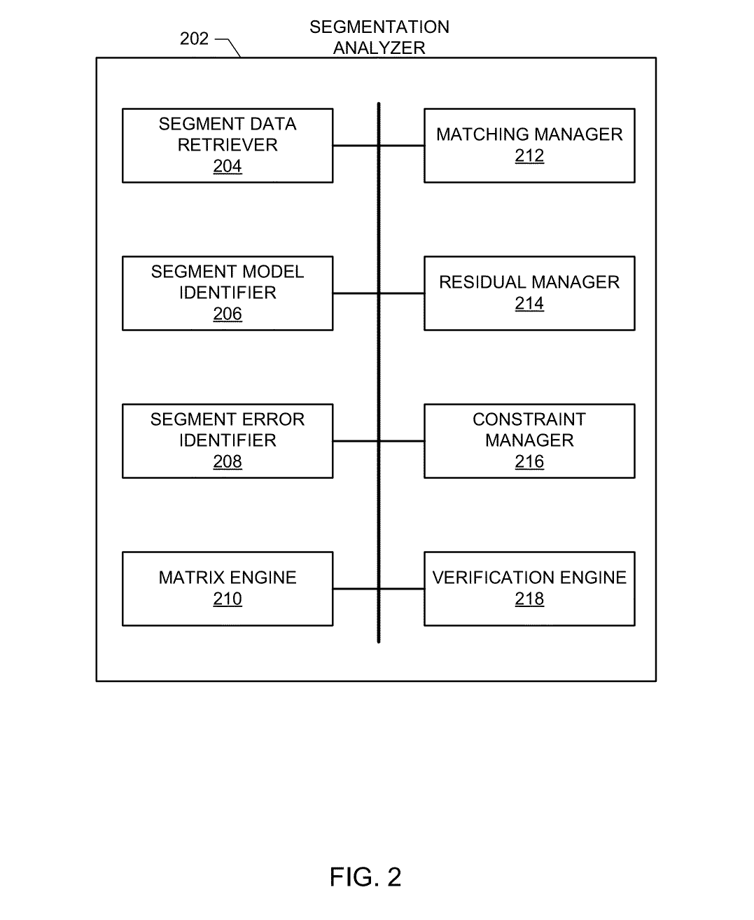

FIG. 2 is a schematic illustration of an example segmentation analyzer 202 constructed in accordance with the teachings of this disclosure to correct erroneous segments. As used herein, “segmentation” refers to a strategy to divide consumers with similar criteria (e.g., demographics) into different groups (segments). As such, each “segment” refers to a data set associated with a category of interest, such as a demographic group (e.g., males age 18-24). A segment may include any number of data points related to any metric (e.g., a behavior, an activity) including, but not limited to, purchasing behavior, travel behavior, media behavior, weekly consumption of goods, etc. As used herein, “media” refers to any type of audio, still image, moving image, and/or combinations thereof presented and/or capable of being presented to an audience. Observations for each segment of interest may change over time to illustrate one or more trends (e.g., monthly trends, yearly trends, seasonal trends, etc.). In the illustrated example of FIG. 2, the segmentation analyzer 202 includes a segment data retriever 204, a segment model identifier 206, a segment error identifier 208, a matrix engine 210, a matching manager 212, a residual manager 214, a constraint manager 216, and a verification engine 218.

In operation, the example data segment retriever 204 acquires one or more segments (data sets associated with a category of interest). In the illustrated example, each segment represents a linear model that can be independent and/or otherwise unique with respect to other models. In the example of FIG. 2, particular model(s) of interest are used when correcting the erroneous data that may be associated with one or more other models (segments), as described in further detail below. An example segment model may be represented in a manner consistent with Equation 1.

Y=Xβ+ε Equation 1.

In example Equation 1, Y reflects a matrix of true recorded amounts (observational data), X reflects a design matrix for a linear model associated with the segment, β reflects coefficients for the linear model, and E reflects the error. In some examples, the design matrix (X) is constructed to consider time varying components, such as trends in weeks, months and/or other seasonal variations. However, problems may occur in the event that the model (e.g., the linear model design matrix (X)) is related to one or more other models and includes errors, such as where members of one or more groups are accidentally counted as members of one or more other groups. Rather than throwing away segments or portions of segments that contain errors, as was done in the past, example methods, apparatus, systems and/or articles of manufacture disclosed herein correct erroneous data by applying derived constants to the model(s). The portions of the model(s) having errors and/or inconsistencies are corrected with constants that fit the model as best as possible. However, these corrections are done in view of other segments of interest that may include valuable information that caused and/or was affected by the error(s) (e.g., data samples from a first segment erroneously labeled as members of a second segment). In some examples, the other segments of interest are in the same segment group as the segment(s) that contain the error(s).

The example segment error identifier 208 of the illustrated example determines which segments and/or which portions of segments include one or more error threshold violations. As described above, error threshold violations may be determined based on data point values and/or ranges of data point value extremes within a corresponding segment. For example, a segment exhibiting magnitude swings that exceed a threshold over a given period of time are considered to exhibit error threshold violations. In some such examples, the example segment error identifier 208 determines which portion(s) of a corresponding segment include errors. This enables application of correction to the erroneous portion(s) of the segment rather than applying correction efforts on entire segments. This avoids changing portions of segments that are otherwise valid and error free. As such, computational efficiency is improved because processor cycles are used to selectively correct only the data in need of adjustment.

As described in further detail below, for each segment identified by the example segment error identifier 208 as having some error, the example matrix engine 210 of FIG. 2 generates a design matrix (X) for the corresponding segment, and an indicator vector (V) to reflect which data points of the corresponding segment should be considered as a group to be adjusted by a corresponding unknown constant value (c) (e.g., a positive or negative value, as needed). Because a particular segment of interest may have errors in all data points, or errors in only some data points, the example indicator vector V generated by the example matrix engine 210 of the illustrated example is defined to have a size (N, k), where each column (k) is a group of observations that should be collectively treated, and N reflects a total number of observations (e.g., data points) across all segments collectively. For example, in the illustrated example of FIG. 1, data points from the example fourth segment 108 exhibit abnormal behavior between the fourth quarter of 2011 (120) and the first quarter of 2012 (122), relative to the consistent behavior shown earlier between the first quarter 2009 (114) and the fourth quarter of 2011 (120). As described above, abnormal behavior may be identified by one or more changes in consistent behavior, or a trend break, such as the example trend break occurring in the fourth quarter of 2011 (120). The example indicator vector V may include a first portion of elements to identify that these particular data points should be treated in a collective manner and be subjected to the same unknown constant value c. On the other hand, data points from the example third segment 106 exhibit abnormal behavior between the fourth quarter of 2011 (120) and the first quarter of 2012 (122), relative to the consistent behavior shown earlier between the first quarter 2009 (114) and the fourth quarter of 2011 (120). As described above, abnormal behavior may be identified by one or more changes in consistent behavior, or a trend break occurring (in this example) during the fourth quarter of 2011 (120). As such, the example indicator vector V may include a second portion of elements to identify that these particular data points should be treated in a collective manner and be subjected to a separate/different unknown constant value c. As such, one or more unknown constant value(s) (c) will be added to all members of a particular group within the column of the indicator vector V. The rows of the indicator vector V are the number of total observations (N=nᵢ+ . . . +nₘ), in which each element of the example indicator vector V is either a 0 or a 1 depending on if that particular observation should be considered within the same group defined by the corresponding column.

Example methods, apparatus, systems and/or articles of manufacture disclosed herein seek values of c in which example Equation 1 above yields a minimum of residual sum of squares consistent with Equation 2. Generally speaking, residuals reflect a difference between a model (e.g., the design matrix (X) for a corresponding segment) prediction and post-corrected values. Such differences are determined as a result of adding different unknown constants (e.g., columns of V) in a manner to align the data with the model (X). The residuals are squared to ensure positive values are used, and the resulting sum (quantity) reflects a degree of performance.

Y_{c}=Y+cV=Xβ+ε Equation 2.

In example Equation 2, Y reflects a column vector of all observational data, and Yc reflects a column vector of corrected values of Y via the unknown constant value c. Additionally, multiple unknown constants c may be considered, one for each column of the indicator vector V. The column vector of observational data Y may be represented with example Equation 3.

$$Y = [ \begin{matrix}{Y}_{1} \\ {Y}_{2} \\ {Y}_{3} \\ {Y}_{4} \\ … \\ {Y}_{m}\end{matrix} ] . \qquad Equation 3$$

In the illustrated example of Equation 3, the first n₁ values (e.g., Y₁, Y₂, . . . , Yₙ) belong to a first segmentation of interest, and so on until a last nₘ group of values (e.g., Y₁₀₁, Y₁₀₂, Y₁₀₃, . . . , Yₘ) belong to an m^{th} and final segmentation of interest.

Additionally, the example matrix engine 210 of FIG. 2 generates a corresponding square identity matrix having a size equal to a number of data points within the segment of interest, in which diagonal values are set to a value of 1 and all other values are set to zero. In addition, the example matrix engine 210 of FIG. 2 generates a projection matrix (sometimes referred to herein as a hat matrix) to map observed values to values that will fit the model. The hat matrix facilitates generation of predicted values of the observation data in view of the corresponding segment model. In other words, the hat matrix transforms the recorded values to estimated/predicted values. When the original (recorded) values are subtracted out, the corresponding result includes the residuals, also referred to as a degree of deviation. In some examples, the matrix engine 210 generates the hat matrix consistent with Equation 4.

Hᵢ=Xᵢ(Xᵢ^{T}Xᵢ)⁻¹Xᵢ^{T} Equation 4.

In the illustrated example of Equation 4, Hᵢ refers to the hat matrix for the i^{th} segment of interest, and Xᵢ refers to the design matrix for the i^{th} segment of interest. The design matrix is a matrix form representation of the model for the i^{th} segment. Additionally Xᵢ^{T} refers to the transpose of the design matrix for the i^{th} segment of interest. The hat matrix (H) is sometimes referred to as a projection matrix, and is used to map the vector of observed values to the vector of fitted values. The example hat matrix (H) of Equation 4 may be used to build and correct a corresponding error matrix (Eᵢ). The example error matrix takes recorded values and converts them into the errors to be minimized (as the design matrix predicts the errors in which the linear model is used, and reflects a distance from the centroid of every observation). In particular, observations that are relatively far from a centroid of the example design matrix (X) also exhibit a relatively greater influence of error, and observations near the centroid have correspondingly smaller entries. For each segment of interest, the example matrix engine 210 generates the corresponding error matrix (Eᵢ) consistent with Equation 5.

Eᵢ=Iₙ₍ᵢ₎−Hᵢ Equation 5.

In the illustrated example of Equation 5, Iₙ₍ᵢ₎ refers to the identity matrix, which can be sized based on a number of observations n(i). Each segmentation processed by examples disclosed herein is not constrained to contain segments that each have the same number of observations. Rather, each segmentation may have any number of observations different from other segments and different from the number of observations associated with the linear model. Additionally, the error matrix Eᵢ is sized by the example matrix engine 210 to form a block diagonal matrix for each of the segments of interest (i=1, . . . , m) consistent with Equation 6.

$$E = [ \begin{matrix}{E}_{1} & … & 0 \\ ⋮ & ⋱ & ⋮ \\ 0 & … & {E}_{m}\end{matrix} ] . \qquad Equation 6$$

As described above in connection with example Equation 2, the minimized residual sum of squares is determined as a function of the unknown constant c. However, in the event additional unknown constants (c) are to be associated with particular segments of interest and/or particular portions of segment(s) of interest, such additional unknown constants are represented as the vector of corrections (C). A plural number of unknown constants (c) is sometimes referred to herein as a vector of corrections (C) that is solved for simultaneously, but examples disclosed herein may also solve for a single unknown constant.

A residual sum of squares (RSS) may be represented consistent with example Equation 7.

$$R S {S}_{C} = {r}_{C}^{T} {r}_{C} = {( E ( Y + VC ) )}^{T} E ( Y + VC ) . \qquad Equation 7$$

In the illustrated example of Equation 7, r_{C} reflects the residuals as a function of the vector of corrections (C). When minimizing the RSS as a function of the vector C in the illustrated example of Equation 7, simplification may be realized by also minimizing ½ RSS_{C}. Considering an orthogonal property of the error matrix E and expanding terms, ½ RSS_{C} may be expressed using example Equation 8.

$$\frac{1}{2} R S {S}_{C} = \frac{1}{2} {C}^{T} {V}^{T} EVC + {( {V}^{T} EY )}^{T} C + {Y}^{T} EY . \qquad Equation 8$$

In the illustrated example of Equation 8, the last term (Y^{T}EY) is independent of the vector of corrections C and, thus, does not contribute to any minimization. This observation allows the first two terms to be rewritten and simplified into standard quadratic form as shown in example Equation 9. Equation 9 has simplification variables Q and B shown as example Equations 10 and 11.

$$\begin{matrix}\frac{1}{2} {C}^{T} QC + {B}^{T} C . & Equation 9 \\ Q = {V}^{T} EV . & Equation 10 \\ B = {V}^{T} EY . & Equation 11\end{matrix}$$

In an effort to identify data correction opportunities while considering interrelationships between two or more segments of interest (e.g., corrections to errors caused by inadvertently mis-categorizing segment labels), example methods, apparatus, systems and/or articles of manufacture disclosed herein introduce one or more constraints on the unknown constants. Generally speaking, constraints guide and/or otherwise direct the manner in which the unknown constants are applied to the one or more segments of interest (e.g., the example first segment 102, the example second segment 104, the example third segment 106, the example fourth segment 108 and/or the example fifth segment 110). The constraints, when applied, allow one or more aspects of conditional or environmental details to be considered in an effort to apply one or more market circumstances. For instance, constraints may be applied to sum all of the applied unknown constants of the two or more segments in a net-zero manner, such that as many additions to one segment are equally balanced by subtracting from other segment(s). In other words, the example constraints may enable a conservation of an amount balanced in between segments.

In some examples, no constraints are applied to the vector of corrections C. In some such examples, the matrix engine 210 solves the vector of corrected values of Y (i.e., Y_{C}) and generates simplification terms R and S using example Equations 12 and 13.

R=V^{T}E Equation 12.

S=RVR Equation 13.

The example matrix engine 210 applies the simplification terms R and S to the vector of corrections C using example Equation 14. Equation 14 is then further applied to the example quadratic form of Equation 2 above.

C=−(SV)⁻¹(SY) Equation 14.

The vector of corrected values (Y_{C}) is now given by Y_{C}=Y+VC.

However, in the event constraints (D) are to be considered when generating the example vector of corrections C to be applied to the vector of corrected values Y_{C}, the example matrix engine 210 subjects the constraint D to the vector of corrections C, as shown in example Equation 15.

PC=D Equation 15.

In the illustrated example of Equation 15, P reflects a matrix to define the constraint the vector of corrections (C) should satisfy. Stated differently, P reflects a matrix to define which corrections to add or subtract, and by how much to add or subtract so that they satisfy one or more constraints (D). Additionally, the example matrix engine 210 of FIG. 2 applies the constraint D with Lagrange system multipliers (λ) and simplification variables Q and B using example Equation 16. The example Lagrange multipliers are used to solve for the Quadratic form with constraints, in which example Equation 16 can be simplified.

$$[ \begin{matrix}Q & {P}^{T} \\ P & 0\end{matrix} ] [ \frac{C}{λ} ] = [ \frac{- B}{D} ] . \qquad Equation 16$$

The vector of constraints (C) may be solved from example Equation 16 by any matrix technique to yield the form as shown in example Equation 17.

Y_{C}=Y+VC Equation 17.

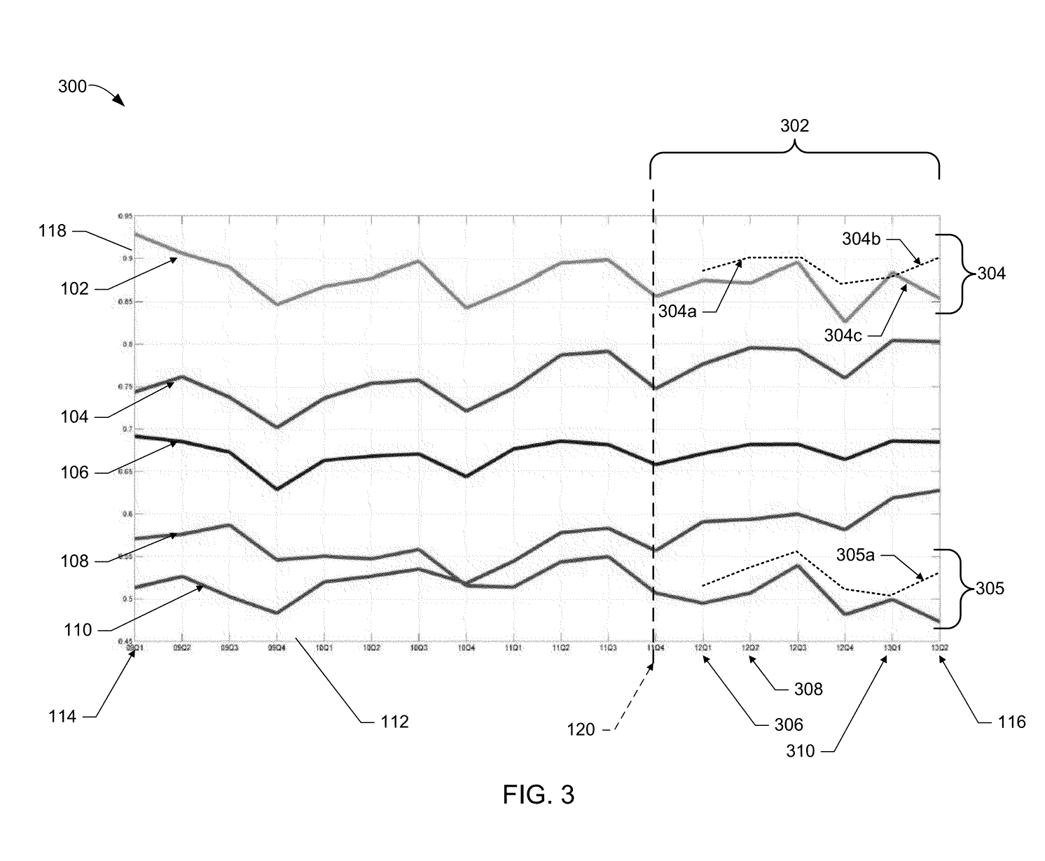

Any number of iterative attempts of applying the example constraint D to the example of observational data Y may be performed and/or compared with the example verification engine 218 of FIG. 2. Additionally or alternatively, the example matching manager 212 of FIG. 2 may select one or more alternate groups of observational data for collective treatment. In such an example, new/alternate corrected values Y_{C} may be calculated. For example, a first iteration of evaluation of the example segment group 111 may have selected data points from all five (5) segments, while a second iteration of evaluation of the example segment group 111 may have selected data points only from a subset of the segments (e.g., the example first segment 102, the example third segment 106, and the example fourth segment 108). In other words, the second iteration of evaluation of the example segment group 111 selects only the segments that appear to exhibit a particular degree (e.g., a threshold amount) of error, while ignoring one or more alternate segments that appear to exhibit error free behavior (e.g., data points exhibiting a span within a threshold magnitude). In some examples, the verification engine 218 compares the corrected values of observational data Y_{C} to results obtained using traditional methods of discarding the erroneous data and extrapolating prior time-periods of good data, as shown in FIG. 3. In circumstances involving a constrained system, the corrected values of observational data Y_{C} are solved simultaneously.

In the illustrated example of FIG. 3, a plot 300 of the five (5) example segments of FIG. 1 is shown having the same reference numbers as explained in FIG. 1 (i.e., the first segment 102, the second segment 104, the third segment 106, the fourth segment 108 and the fifth segment 110). FIG. 3 also includes the horizontal axis of time 112 from the first quarter of 2009 (114) to the second quarter of 2013 (116), and a vertical axis of normalized magnitude values 118. Unlike the illustrated example of FIG. 1, the five (5) segments have been corrected using the techniques disclosed above to reflect corrected values for the erroneous data between an erroneous period 302, which includes the fourth quarter of 2011 (120) and the second quarter of 2013 (116). In the example erroneous period 302 of FIG. 3, solid lines for corresponding segments reflect corrected values calculated by way of example methods, apparatus, systems and/or articles of manufacture disclosed herein. However, in that same period 302, dashed lines represent results produced via the traditional manner of analysis in which data from the erroneous period 302 is deleted/discarded and replaced with data based upon one or more earlier time periods of satisfactory data. In some examples, a traditional analysis generates predictions from only consistent portions of collected data, which ignores any useful information from the abnormal data.

An example first difference zone 304 and an example second difference zone 305 are generated by the example verification engine 218 to illustrate one or more differences between the results obtained by an example traditional data-replacement technique (see dashed lines) and example correction techniques disclosed herein. The example first difference zone 304 illustrates failures of the traditional data-replacement technique to consider and/or otherwise identify trending information that is lost and/or otherwise discarded via that traditional data-replacement technique. In particular, relying on a prior time period model and discarding the erroneous data per the prior example techniques results in an indication that the corresponding data trend exhibits an upward/positive behavior 304a between a first quarter of 2012 (306) and a second quarter of 2012 (308). Additionally, discarding the erroneous data per the prior example techniques results in an indication that the corresponding data trend exhibits an upward/positive behavior 304b between a first quarter of 2013 (310) and the second quarter of 2013 (116). However, using techniques defined herein to maintain the erroneous data (rather than discarding it per the prior example techniques) and applying corrections as disclosed above, a negative trend 304c can be shown between the first quarter of 2013 (310) and the second quarter of 2013 (116). In particular, erroneous trending information that would result via the prior example techniques may be avoided by correcting the data rather than replacing the data, thereby preventing marketing campaign failures. Similar disparities between discarding erroneous data rather than correcting the erroneous data is evident in the illustrated example of FIG. 3 with respect to an example trend inconsistency 305a shown in the example second difference zone 305 in the example fourth segment 108 between the first quarter of 2013 (310) and the second quarter of 2013 (116). In particular, traditional approaches of discarding data lose the ability to identify true trending behaviors.

While an example manner of implementing the segmentation analyzer 202 of FIG. 2 is illustrated in FIGS. 1-3, one or more of the elements, processes and/or devices illustrated in FIG. 2 may be combined, divided, re-arranged, omitted, eliminated and/or implemented in any other way. Further, the example segment data retriever 204, the example segment model identifier 206, the example segment error identifier 208, the example matrix engine 210, the example matching manager 212, the example residual manager 214, the example constraint manager 216, the example verification engine 218 and/or, more generally, the example segmentation analyzer 202 of FIG. 2 may be implemented by hardware, software, firmware and/or any combination of hardware, software and/or firmware. Thus, for example, any of the example segment data retriever 204, the example segment model identifier 206, the example segment error identifier 208, the example matrix engine 210, the example matching manager 212, the example residual manager 214, the example constraint manager 216, the example verification engine 218 and/or, more generally, the example segmentation analyzer 202 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, segment data retriever 204, the example segment model identifier 206, the example segment error identifier 208, the example matrix engine 210, the example matching manager 212, the example residual manager 214, the example constraint manager 216, the example verification engine 218 and/or, more generally, the example segmentation analyzer 202 of FIG. 2 is/are hereby expressly defined to include a tangible computer readable storage device or storage disk such as a memory, a digital versatile disk (DVD), a compact disk (CD), a Blu-ray disk, etc. storing the software and/or firmware. Further still, the example segmentation analyzer 202 of FIG. 2 may include one or more elements, processes and/or devices in addition to, or instead of, those illustrated in FIG. 2, and/or may include more than one of any or all of the illustrated elements, processes and devices.

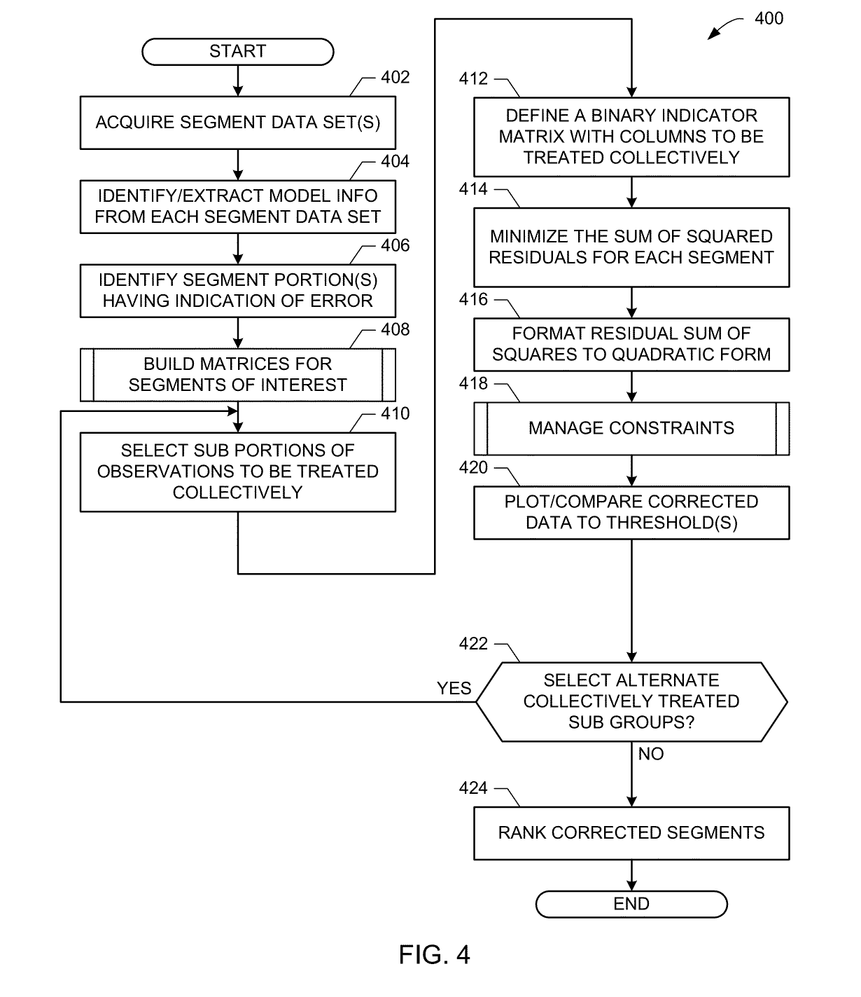

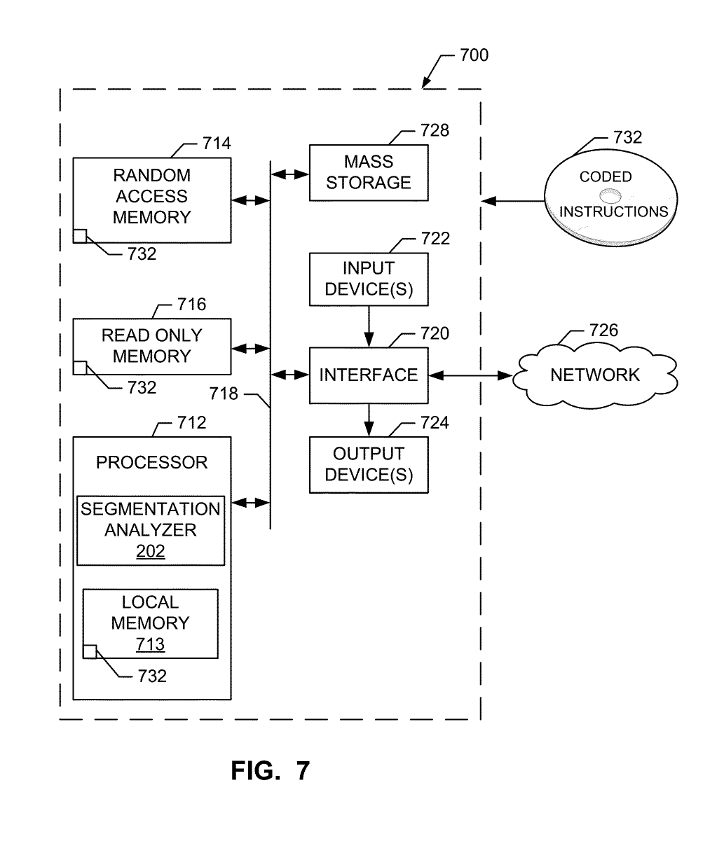

Flowcharts representative of example machine readable instructions for implementing the segmentation analyzer 202 of FIG. 2 are shown in FIGS. 4-6. In these examples, the machine readable instructions comprise one or more program(s) for execution by a processor such as the processor 712 shown in the example processor platform 700 discussed below in connection with FIG. 7. The program(s) may be embodied in software stored on a tangible computer readable storage medium such as a CD-ROM, a floppy disk, a hard drive, a digital versatile disk (DVD), a Blu-ray disk, or a memory associated with the processor 712, but the entire program(s) and/or parts thereof could alternatively be executed by a device other than the processor 712 and/or embodied in firmware or dedicated hardware. Further, although the example program(s) is/are described with reference to the flowcharts illustrated in FIGS. 4-6, many other methods of implementing the example segmentation analyzer 202 may alternatively be used. For example, the order of execution of the blocks may be changed, and/or some of the blocks described may be changed, eliminated, or combined.

As mentioned above, the example processes of FIGS. 4-6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 4-6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program 400 of FIG. 4 begins at block 402 where the example data segment retriever 204 acquires segment data sets. As described above, a market analysis may include any number of segments of interest in which each segment is intended to reflect behaviors of a particular type of consumer (e.g., a certain demographic). However, because segment data errors may occur prior to any market analysis, each corresponding segment data set may have inherent problems and/or errors that would result in problematic conclusions after segment analysis. For example, a segment error in which data from a first segment is erroneously associated with a second segment may result in an overrepresentation for the second segment.

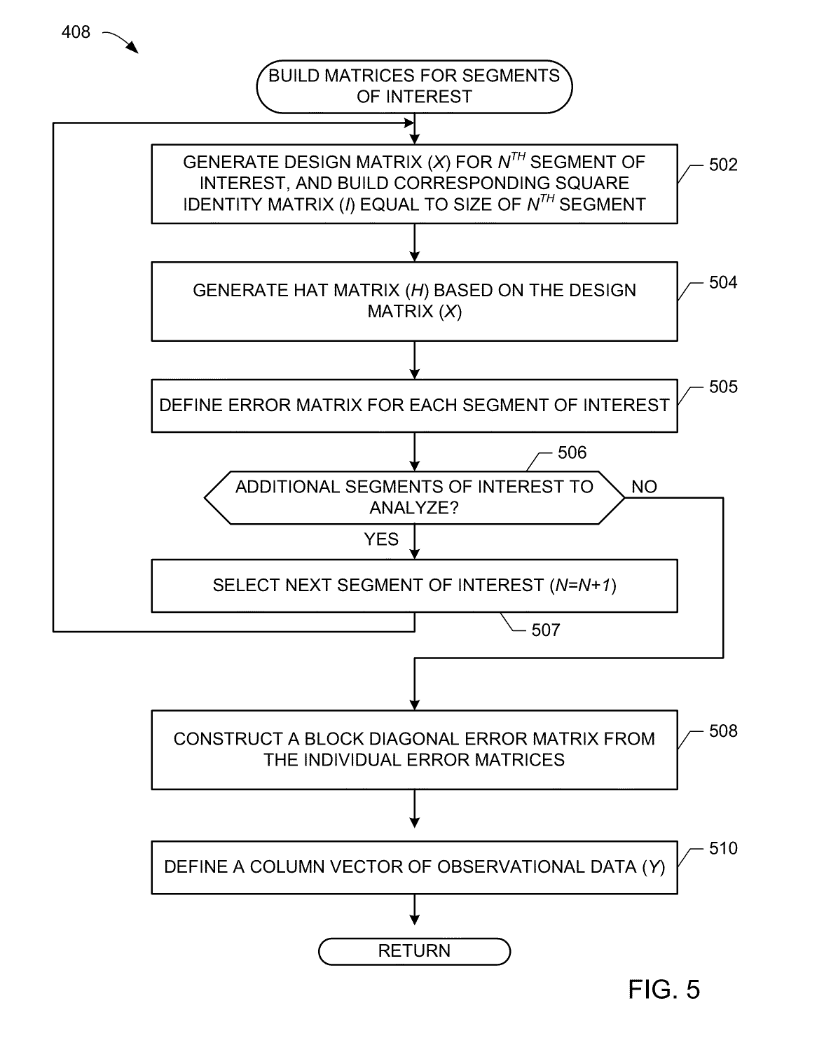

The example segment model identifier 206 identifies and/or otherwise extracts model information from each segment data set of interest (block 404), and the example segment error identifier 208 determines which portion(s) of each segment of interest reflect an indication of error (block 406). As described above in connection with FIG. 1, segment error may be determined in any number of ways, such as data magnitude threshold violations and/or data span threshold violations. For each first segment of interest, the example matrix engine 210 builds matrices associated with the segment data sets (block 408), as described in further detail in FIG. 5.

FIG. 5 includes additional detail related to building matrices associated with the segment data sets (block 408). In the illustrated example of FIG. 5, the matrix engine 210 generates a design matrix (X) and a corresponding square identity matrix (I) having a size equal to a number of data points within the segment (block 502). As described above in connection with example Equation 4, the example matrix engine 210 generates a hat matrix for the segment of interest (block 504), defines an error matrix for the selected segment of interest (block 505), and determines if additional segments of interest are to be analyzed (block 506). If so, a next segment of interest is identified (block 507) and control returns to block 502. After each segment of interest has a corresponding generated design matrix (X), identity matrix (I) and hat matrix (H), the example matrix engine 210 constructs a block diagonal error matrix from the individual error matrices in a manner consistent with example Equations 5 and 6 (block 508). A column vector of observational data is generated by the example matrix engine 210 that reflects all observational data for the selected segments of interest (block 510).

Returning to the illustrated example of FIG. 4, the matching manager 212 selects sub portions of observations that are to be treated in a collective manner (block 410), and based on the selected sub portions of observations, the matching manager 212 generates a binary indicator matrix (V) (block 412). In some examples, an analyst may generate one or more selections via a graphical user interface (GUI) that result in particular groups of observations that are to be treated collectively. The example binary indicator matrix V is of size (N, k), where each column is a group of observations that should be treated collectively, in which the same constant will be added (or subtracted) to all members of that group within the column. Rows of the example binary indicator matrix V reflect a total number of observations N=nᵢ+ . . . +nₘ, and each element in the matrix V is either a 0 or 1 depending on whether that particular observation should be considered within the same group defined by the column of interest. Any collective group may include observations across segmentations at one or more points in time, across time in one or more segmentations, or both.

Prior to determining values for constants to be applied to the observational data, example methods, apparatus, systems and/or articles of manufacture disclosed herein determine a discrepancy between the observational data and models associated with the segments of interest. For example, the residual manager 214 minimizes a sum of squared residuals for each segment (model) collectively to simultaneously solve for the unknown constants (block 414), as described above in connection with example Equation 7. The example residual manager 214 formats a simplification of the RSSc of Equation 7 to the quadratic form (block 416) as shown by example Equation 9, which facilitates the ability to apply constraints to segment analysis (block 418).

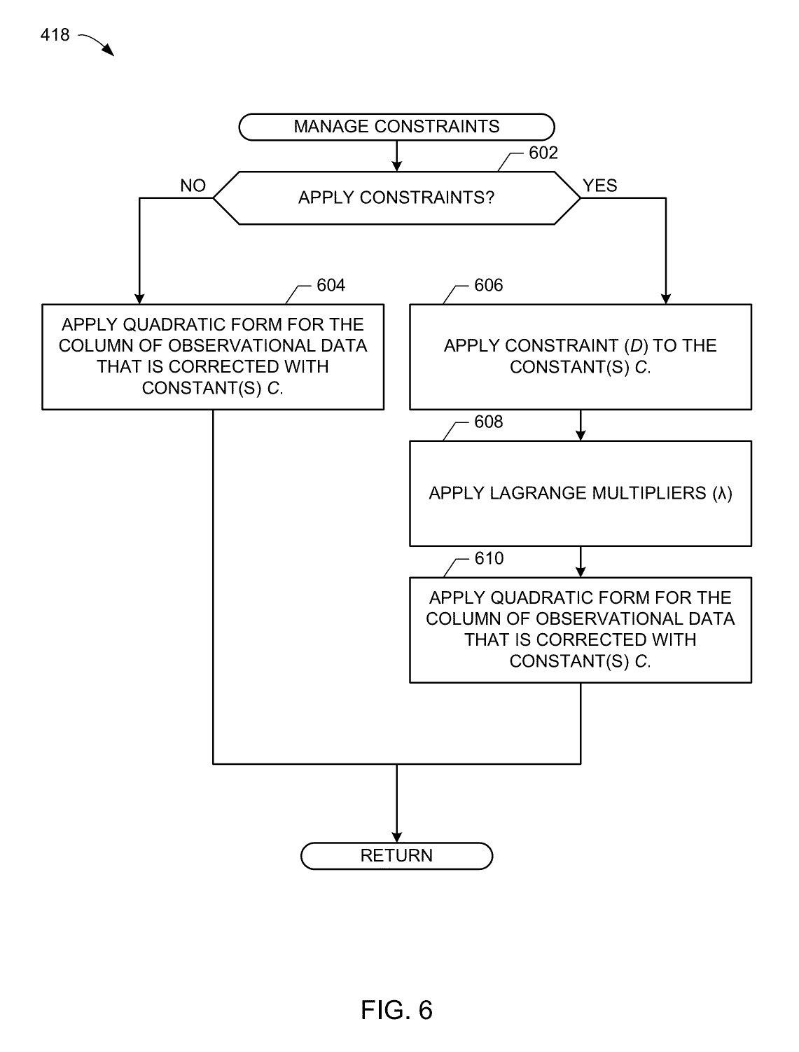

FIG. 6 includes additional detail related to managing constraints during segment analysis (block 418). In the illustrated example of FIG. 6, the constraint manager 216 determines whether the current selection of segments and/or sub portions of observations associated with the selected segments should also have applied constraints (block 602). If not, then the example constraint manager 216 applies the quadratic form of example Equation 2 to the column of observational data that is corrected by the unknown constant c (block 604). However, in some examples a constraint is applied to the segment analysis, particularly when one or more relationships between segments of interest exhibit clues that categorization errors have occurred. For example, while one or more individual segments may exhibit relatively large magnitude swings during one or more time periods (e.g., magnitude swings that exceed one or more threshold values), an aggregated sum of all segments of interest may not reveal erroneous results (e.g., an end-of-year revenue for a product is consistent with expectations). In such examples, application of one or more constraints helps to improve the accuracy of the segmentation analysis.

An example constraint may include, but is not limited to forcing the sum of all individual segments of interest to a target value. The example target value may be a percentage (e.g., 100% of sales), or a specified metric (e.g., $1000 of products sold). In some examples, if the unknown constant is applied to a first segment of interest in an effort to correct the data within that first segment, then a constraint may require that a second segment of interest remove an equivalent constant quantity from its corresponding data values. Stated differently, sourcing values from any one segment requires a corresponding sinking of values from one or more different segment(s) to maintain an overall balance of sums. In other examples, a constraint may require that a first segment must apply the unknown constant value by a multiplicative factor greater than or less than a second segment. In still other examples, a constraint may require that unknown constant values are to be applied to the uncorrected segment data sets as a linear function of time.

In the event a constraint is to be applied to the unknown constant(s) (block 602), then the example constraint manager 216 applies the constraint vector (D) to the constants vector (C) in a manner consistent with example Equation 15 (block 606). As described above, convenience/simplification values Q and B are applied by the example matrix engine 210 to example Equation 16, which is solved simultaneously along with the constraint vector D to apply Lagrange multipliers 2 to the system (block 608). The example matrix engine 210 solves example Equation 16 to derive the quadratic form of example Equation 2 (block 610), which reveals the vector of corrected values Y_{C}.

In some examples, any number of variations include (a) selecting particular segments of interest, (b) selecting particular portions of segments of interest and/or (c) applying constraints to the selected segments of interest may occur. In still other examples, simultaneously solved results may be compared to results that are typically obtained when suspected erroneous data is deleted and replaced rather than corrected, which may expose divergent trending information as described above in connection with FIG. 3.

The example verification engine 218 plots and/or otherwise compares corrected data Y_{C} to one or more thresholds, one or more segment analysis results, and/or one or more results obtained through traditional erroneous data deletion techniques (block 420). If the example matching manager 212 identifies a request to repeat segment analysis using an alternate sub portion of segment data to be treated as a group (e.g., a sub portion of segments in which the unknown constant is applied uniformly) (block 422), then control returns to block 410 of FIG. 4. Otherwise, the example segmentation analyzer 202 ranks the one or more segment analysis iterations to determine which unknown constant and/or constraint results in a preferred correction Y_{C} (block 424). For example, a first combination of segments having erroneous observation data may result in a first correction of observation data Y_{C1}, and a second combination of segments having erroneous observation data may result in a second correction of observation data Y_{C2}. For the sake of illustration, assume that the first correction of observation data Y_{C1} reflects a data span of 0.16 units, and the second correction of observation data Y_{C2} reflects a data span of 0.05 units. An example reason for this disparity between observation data correction values is that the first combination of segments selected may not have been the pair of segments in which labeling information was erroneously switched. Thus, the attempts to correct observation data between that example pair of segments will not result in a correction indicative of acceptable expectations (e.g., a data span value less than 0.15 units). On the other hand, assume that the second correction of observation data Y_{C2} included a selection of two segments in which labeling data was inadvertently switched. After application of example corrections disclosed herein, the resulting corrected observation data Y_{C2} exhibits a data span (0.05 units) much closer to expected and/or otherwise acceptable levels. In other examples, any number of additional corrections of observation data (Y_{C}) may be analyzed and ranked.

FIG. 7 is a block diagram of an example processor platform structured to 700 execute the instructions of FIGS. 4-6 to implement the segmentation analyzer 202 of FIG. 2 The processor platform 700 can be implemented as, for example, a server, a personal computer, a mobile device (e.g., a cell phone, a smart phone, a tablet such as an iPad™), a personal digital assistant (PDA), an Internet appliance, a digital video recorder, a gaming console, a set top box, or any other type of computing device.

The processor platform 700 of the illustrated example includes a processor 712. The processor 712 of the illustrated example is hardware. For example, the processor 712 can be implemented by one or more integrated circuits, logic circuits, microprocessors or controllers from any desired family or manufacturer. The processor 712 also includes the example segmentation analyzer 202, which includes the example segment data retriever 204, the example segment model identifier 206, the example segment error identifier 208, the example matrix engine 210, the example matching manager 212, the example residual manager 214, the example constraint manager 216, and/or the example verification engine 218.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display, a cathode ray tube display (CRT), a touchscreen, a printer and/or speakers). The interface circuit 720 of the illustrated example, thus, typically includes a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The processor platform 700 of the illustrated example also includes one or more mass storage devices 728 for storing software and/or data. Examples of such mass storage devices 728 include floppy disk drives, hard drive disks, compact disk drives, Blu-ray disk drives, RAID systems, and digital versatile disk (DVD) drives.

The coded instructions 732 of FIGS. 4-6 may be stored in the mass storage device 728, in the volatile memory 714, in the non-volatile memory 716, and/or on a removable tangible computer readable storage medium such as a CD or DVD.

From the foregoing, it will be appreciated that methods, systems, apparatus and/or articles of manufacture have been disclosed which reduce (e.g., minimize and/or eliminate) wasteful discard of erroneous segmentation data in one or more marketing campaigns. Rather than merely deleting portions of segmentation data that appear to have errors, and replacing such erroneous data with one or more prior time-periods of data, examples disclosed herein correct the erroneous data so that trending information is not lost when performing a market analysis. Examples disclosed herein also reduce computational waste by correcting only such segments that appear to have errors, rather than applying correction factors to observation data that otherwise exhibits normal behavior. One or more results obtained from example methods, systems, apparatus and/or articles of manufacture disclosed herein include the original erroneous observation segment data corrected by a correction factor, thereby preserving any trending information within the original observation data. Derived constants may be applied to one or more segments in a manner that minimizes the residual sum of squares, and one or more constraints may be applied to cause the constants to be applied in a manner that conforms to market conditions (e.g., doubling a multiplication factor of the constant for a particular segment due to seasonality expectations).

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to correct a misclassification error in segment data, comprising:
identifying, with a processor, a segment group comprising observation data associated with two or more segments, respective ones of the two or more segments exhibiting a shared behavior characteristic and a dissimilar classification characteristic;
identifying first portions of the observation data exhibiting errors;
generating a first matrix of binary indicators associated with the observation data, the binary indicators associating the first portions of the observation data with a first correction factor;
generating a value for the first correction factor by minimizing a residual sum of squares of the segment group observation data associated with the first matrix of binary indicators; and
correcting the misclassification error by applying the first correction factor to the observation data based on the first matrix of binary indicators.

2. A method as defined in claim 1, further comprising identifying a magnitude span value satisfying a threshold to identify the observation data having errors.

3. A method as defined in claim 1, wherein the shared behavior characteristic comprises a consumer behavior.

4. A method as defined in claim 3, wherein the consumer behavior comprises at least one of product purchases, brand purchases, media consumption, or travel.

5. A method as defined in claim 3, wherein the dissimilar classification characteristic comprises a type of demographic associated with the consumer behavior.

6. A method as defined in claim 1, further comprising generating a hat matrix to convert the observation data into a predicted value based on a model associated with the two or more segments.

7. A method as defined in claim 1, further comprising applying a first constraint to the first correction factor.

8. A method as defined in claim 7, further comprising preserving a sum total of the two or more segments with the first constraint to cause observation data of a first one of the two or more segments to gain by a function of the first correction factor in a manner proportional to a loss to a second one of the two or more segments.

9. A method as defined in claim 1, further comprising generating a second correction factor based on a second matrix of binary indicators, the second matrix of binary indicators to associate second portions of the observation data with the second correction factor.

10. A method as defined in claim 9, further comprising:
calculating a first data span value of the observation data corrected by the first correction factor;
calculating a second data span value of the observation data corrected by the second correction factor; and
identifying one of the first correction factor or the second correction factor based on a respective lower data span value.

11. An apparatus to correct a misclassification error in segment data, comprising:
a segment data retriever to identify a segment group comprising observation data associated with two or more segments, respective ones of the two or more segments exhibiting a shared behavior characteristic and a dissimilar classification characteristic;
a segment error identifier to identify first portions of the observation data exhibiting errors;
a matrix engine to generate a first matrix of binary indicators associated with the observation data, the binary indicators to associate the first portions of the observation data with a first correction factor; and
a residual manager to generate a value for the first correction factor by minimizing a residual sum of squares of the segment group observation data associated with the first matrix of binary indicators, and to correct the misclassification error by applying the first correction factor to the observation data based on the first matrix of binary indicators.

12. An apparatus as defined in claim 11, wherein the segment error identifier is to identify a magnitude span value satisfying a threshold to identify the observation data having errors.

13. An apparatus as defined in claim 11, wherein the shared behavior characteristic comprises a consumer behavior.

14. An apparatus as defined in claim 13, wherein the consumer behavior comprises at least one of product purchases, brand purchases, media consumption, or travel.

15. An apparatus as defined in claim 13, wherein the dissimilar classification characteristic comprises a type of demographic associated with the consumer behavior.

16. An apparatus as defined in claim 11, wherein the matrix manager is to generate a hat matrix to convert the observation data into a predicted value based on a model associated with the two or more segments.

17. An apparatus as defined in claim 11, further comprising a constraint manager to apply a first constraint to the first correction factor.

18. An apparatus as defined in claim 17, wherein the constraint manager is to preserve a sum total of the two or more segments with the first constraint to cause observation data of the first one of the two or more segments to gain by a function of the first correction factor in a manner proportional to a loss to a second one of the two or more segments.

19. An apparatus as defined in claim 11, wherein the matrix manager is to generate a second correction factor based on a second matrix of binary indicators, the second matrix of binary indicators to associate second portions of the observation data with the second correction factor.

20. A tangible machine readable storage medium comprising machine accessible instructions that, when executed, cause the machine to, at least:
identify a segment group comprising observation data associated with two or more segments, respective ones of the two or more segments exhibiting a shared behavior characteristic and a dissimilar classification characteristic;
identify first portions of the observation data exhibiting errors;
generate a first matrix of binary indicators associated with the observation data, the binary indicators associating the first portions of the observation data with a first correction factor;
generate a value for the first correction factor by minimizing a residual sum of squares of the segment group observation data associated with the first matrix of binary indicators; and
correct the misclassification error by applying the first correction factor to the observation data based on the first matrix of binary indicators.

21. A machine readable storage medium as defined in claim 20, wherein the machine readable instructions, when executed, cause the machine to identify a magnitude span value satisfying a threshold to identify the observation data having errors.

22. A machine readable storage medium as defined in claim 20, wherein the machine readable instructions, when executed, cause the machine to identify the shared behavior characteristic as a consumer behavior.

23. A machine readable storage medium as defined in claim 22, wherein the machine readable instructions, when executed, cause the machine to identify the consumer behavior as at least one of product purchases, brand purchases, media consumption, or travel.

24. A machine readable storage medium as defined in claim 22, wherein the machine readable instructions, when executed, cause the machine to identify the dissimilar classification characteristic as a type of demographic associated with the consumer behavior.

25. A machine readable storage medium as defined in claim 20, wherein the machine readable instructions, when executed, cause the machine to generate a hat matrix to convert the observation data into a predicted value based on a model associated with the two or more segments.

26. A machine readable storage medium as defined in claim 20, wherein the machine readable instructions, when executed, cause the machine to apply a first constraint to the first correction factor.

27. A machine readable storage medium as defined in claim 27, wherein the machine readable instructions, when executed, cause the machine to preserve a sum total of the two or more segments with the first constraint to cause observation data of a first one of the two or more segments to gain by a function of the first correction factor in a manner proportional to a loss to a second one of the two or more segments.

28. A machine readable storage medium as defined in claim 20, wherein the machine readable instructions, when executed, cause the machine to generate a second correction factor based on a second matrix of binary indicators, the second matrix of binary indicators to associate second portions of the observation data with the second correction factor.
